(19) United States
(12) Patent Application Publication
(10) Pub. No.: US 2012/0106432 A1
(43) Pub. Date: May 3, 2012

(54) METHOD FOR TRANSMITTING UPLINK SIGNAL WITH PERIODIC AND RELAY SYSTEM FOR THE SAME

(76) Inventors: Hee Bong LEE, Seoul (KR); Young Jun Kim, Anyang-si (KR); Sang Ha Kim, Seoul (KR); Byoung-Seong Park, Incheon (KR); Il Doo Chang, Anyang-si (KR); Hong Sup Shin, Seoul (KR)

(21) Appl. No.: 13/016,196

(22) Filed: Jan. 28, 2011

(30) Foreign Application Priority Data
Oct. 29, 2010 (KR) 10-2010-0106833

(51) Int. Cl. H04W 88/04

(52) U.S. Cl. 370/315

(57) ABSTRACT

In one embodiment, after determining downlink backhaul sub-frames based on a constitution period of backhaul sub-frames and determining uplink backhaul sub-frames based on the determined downlink backhaul sub-frames by a relay, all or portions of uplink signals in the determined uplink backhaul sub-frames are transmitted within a backhaul sub-frame allocation period, or after assigning numbers to all of the determined uplink backhaul sub-frames, all or portions of uplink signals are transmitted according to the assigned uplink backhaul sub-frame numbers within a backhaul sub-frame allocation period.

### CROSS-REFERENCE TO RELATED APPLICATIONS

The present application claims priority from Korean Patent Application No. 10-2010-0106833 (filed on Oct. 29, 2010), the entire subject matters of which are incorporated herein by reference.

### TECHNICAL FIELD

The present invention generally relates to an orthogonal frequency division multiple access (OFDMA) based relay system, and more particularly to a method for transmitting control signals, e.g., SRS, SR, CQI/PMI/RI etc., having periodicity in a uplink direction in the relay system.

### BACKGROUND

The relay may be used to cover shadow areas in a cell and installed at cell boundaries to effectively extend cell coverage and enhance throughput.

The relay may be classified into an out-band relay, in which a center frequency of a frequency band used in a backhaul link between a base station and the relay is different from a center frequency of a frequency band used in an access link between the relay and a terminal, and an in-band relay, in which the center frequencies are identical to each other.

A relay of the 3^{rd} generation partnership project (3GPP) has been considering the time division scheme dividing the time domain for the transmission and reception to avoid self-interference (SI). The SI may occur when an identical frequency band is used for transmission and reception frequencies of the relay. That is, the SI is an interference occurring at a receiving antenna when signals are simultaneously transmitted and received at an identical frequency band at a transmitting antenna and the receiving antenna of the relay. More particularly, when a frequency band used between the relay and user equipment is identical to a frequency band used between the base station and the relay (i.e., in-band type), a signal transmitted to the user equipment through the transmitting antenna of the relay may be received by the receiving antenna itself. Thus, when the receiving antenna receives a signal from the base station, an interference may occur. Such SI may occur at not only the downlink but also the uplink.

The so-called “in-band half-duplex type” is a type of using the same frequency band and dividing the time domain for transmission and reception. An in-band half-duplex relay may receive signals from the base station (or user equipment) at a predetermined time and at a predetermined frequency at a downlink (or uplink). After performing error correction on the received signals through digital signal processing, the signals may be modulated to be a suitable transmission format and then retransmitted to the user equipment (or base station). At this time, the relay may not transmit the data to the user equipment (or base station) during the time for receiving the data from the base station (or user equipment). As such, the SI may be avoided by dividing the time domain for the transmission and reception.

In a relay of long term evolution (LTE), physical layer signals of a uplink, which are transmitted from the user equipment to the base station, may include a physical uplink shared channel (PUSCH), a physical uplink shared channel (PUSCH), a physical uplink control channel (PUCCH), a sounding reference signal (SRS) and the like. In control information transmitted through PUCCH, a scheduling request (SR) and channel quality indicator (CQI)/precoding matrix indicator (PMI)/rank indicator (RI) are transmitted in a specific period, and the SRS is also transmitted at a predetermined time interval. That is, the control signals, such as SR, CQI/PMI/RI, SRS and the like, which are transmitted to the uplink, are transmitted with periodicity. Since the sub-frames to be transmitted to the uplink in the relay system are limited, there is a problem that transmission opportunities of the signals having periodicity are decreased.

### SUMMARY

The present invention is directed to providing a method of efficiently transmitting control signals (e.g., SRS, SR, CQI/PMI/RI, etc.) with periodicity on a backhaul uplink and a relay system for the same.

In accordance with one embodiment, a method of efficiently transmitting control signals (e.g., SRS, SR, CQI/PMI/RI, etc.) with periodicity on a backhaul uplink and a relay system for the same are disclosed. According to the present invention, after determining downlink backhaul sub-frames based on a constitution period of backhaul sub-frames and determining uplink backhaul sub-frames based on the determined downlink backhaul sub-frames by a relay, all or portions of uplink signals in the determined uplink backhaul sub-frames within a backhaul sub-frame allocation period are transmitted, or after assigning numbers to all of the determined uplink backhaul sub-frames, all or a portion of uplink signals according to the assigned uplink backhaul sub-frame numbers within a backhaul sub-frame allocation period are transmitted.

Herein, all or portions of the uplink signals in the entire determined uplink backhaul sub-frames are transmitted within a backhaul sub-frame allocation period, or all or portions of the uplink signals in a first sub-frame among the determined uplink backhaul sub-frames are transmitted within a backhaul sub-frame allocation period.

The uplink backhaul sub-frame numbers are sequentially assigned, and transmission sub-frames are determined based on a transmission period of the uplink signals by considering the uplink backhaul sub-frame numbers, and the uplink signals are transmitted at the determined transmission sub-frames.

### BRIEF DESCRIPTION OF THE DRAWINGS

FIG. 1 is a diagram showing configuration of an illustrative relay system.

FIG. 2 is a diagram showing an LTE DL frame structure.

FIG. 3 is a diagram showing an LTE UL frame structure.

FIG. 4 is a diagram showing an example of transmitting signals with periodicity.

FIG. 5 is a diagram showing a signal transmission method of a relay.

FIG. 6 is a diagram showing an example of configuring uplink and downlink backhaul sub-frames.

FIG. 7 is a diagram showing an example of allocating backhaul sub-frames.

FIG. 8 is a diagram showing an example of transmitting signals with periodicity at a backhaul link.

FIG. 9 is a diagram showing an example of transmitting periodic signals considering backhaul sub-frame numbers.

### DETAILED DESCRIPTION

A detailed description may be provided with reference to the accompanying drawings. One of ordinary skill in the art may realize that the following description is illustrative only and is not in any way limiting. Other embodiments of the present invention may readily suggest themselves to such skilled persons having the benefit of this disclosure.

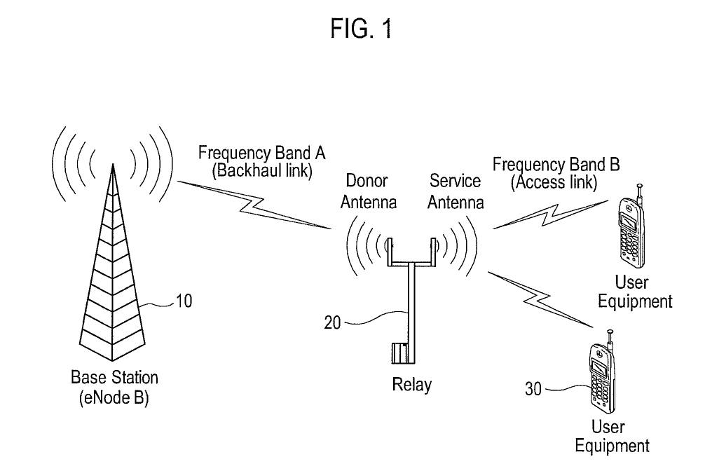

FIG. 1 is a diagram showing an exemplary relay system in which the present invention may be implemented.

As shown in FIG. 1, a relay system 100 may include a base station (eNodeB) 10, a relay 20, and user equipment (UE) 30. In one embodiment, relay 20 may be replaced with a repeater, and a frequency band A for a backhaul link between a base station 10 and the relay 20 may be identical to a frequency band B for an access link between the relay 20 and the UE 30. That is, the relay 20 of the present invention may be an in-band half-duplex relay where the frequency band A and the frequency band B are identical to each other (in-band) and the time domain is divided for transmission and reception.

The relay 20 may include a donor antenna for communicating with the base station 10 and a service antenna for communicating with the user equipment 30, and performs communication arbitration between the base station 10 and the user equipment 30 through the donor antenna and service antenna. Since the relay 20 uses a wireless backhaul for the backhaul link and not a wire backhaul, the relay 20 has an advantage in that it is not required to add a new base station or establish a wire backhaul.

In the downlink (DL) (or uplink (UL)), a relay 20 receives signals from a base station 10 (or user equipment 30) at a predetermined time and at a predetermined frequency, and removes DL or UL SI components therefrom. Thereafter, the relay 20 modulates the signals to a suitable transmission format and retransmits the signals to the user equipment 30 (or base station 10).

An operation of the relay 20 will be described as follows based on an OFDMA based long term evolution (LTE) system.

In the 3GPP LTE system, a multiple bandwidth is defined as in the following Table 1.

TABLE 1

| | Transmission BW (MHz) | | | | | |
|---|---|---|---|---|---|---|
| | 1.4 | 3 | 5 | 10 | 15 | 20 |
| Subframe duration | 1.0 | | | ms | | |
| Subcarrier spacing | 15 | | | kHz | | |
| Physical resource block | 180 | | | kHz | | |
| bandwidth | | | | | | |
| Number of available PRBs | 6 | 12 | 25 | 50 | 75 | 100 |
| Sampling frequency (MHz) | 1.92 | 3.84 | 7.68 | 15.36 | 23.04 | 30.72 |
| FFT size | 128 | 256 | 512 | 1024 | 1536 | 2048 |
| Number of occupied subcarriers | 72 | 180 | 300 | 600 | 900 | 1200 |
| Number of Resource Block | 6 | 15 | 25 | 50 | 75 | 100 |

| | | |
|---|---|---|
| CP length (μs) | Normal | 5.21(first symbol in slot), |
| | | 4.69(except first symbol in slot) |
| | Extended | 16.6 |

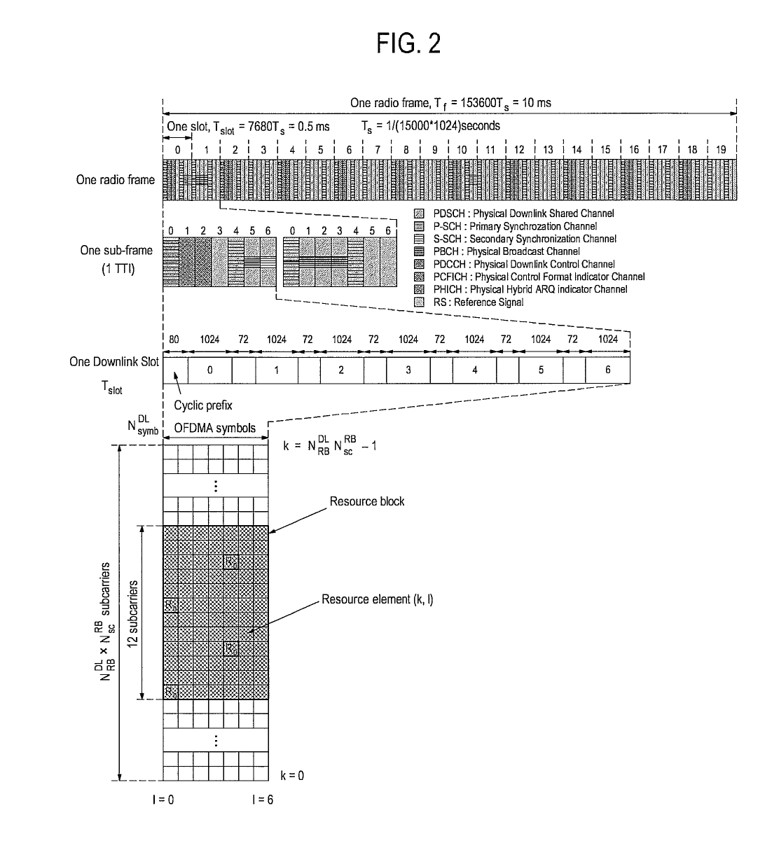

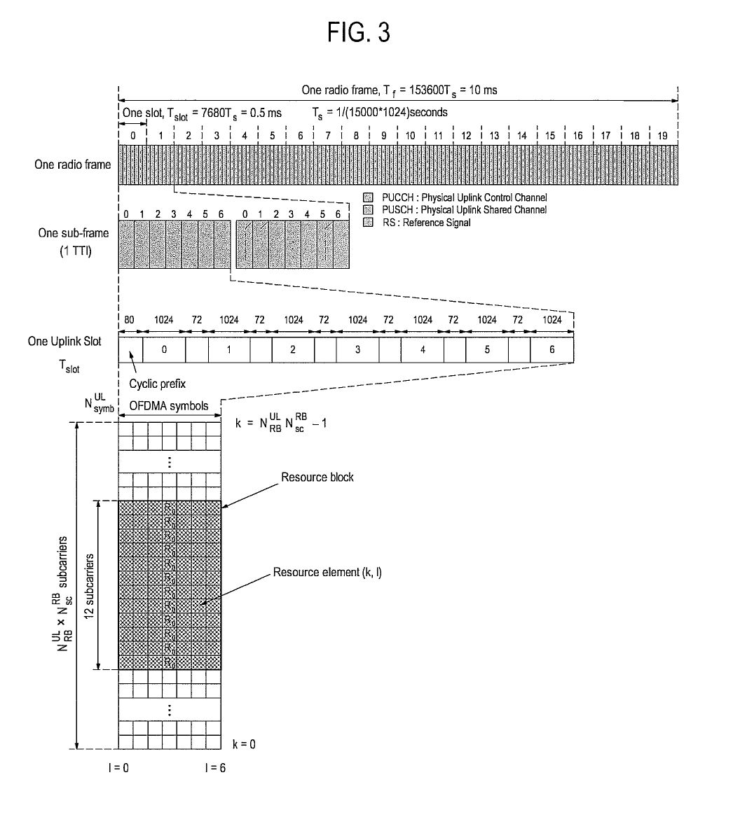

The LTE system is an OFDMA based wireless mobile communication system and has transmission frame structures as shown in FIGS. 2 and 3. FIG. 2 shows an LTE downlink (DL) frame structure having a transmission bandwidth of 10 MHz, and FIG. 3 shows an LTE uplink (UL) frame structure having a transmission bandwidth of 10 MHz.

Referring to FIG. 2, a transmission time interval (TTI) is a minimum transmission unit in the LTE DL frame structure. Each TTI (sub-frame) includes two consecutive slots (an even-numbered slot and an odd numbered slot form a TTI). One slot may include fifty resource blocks (RBs). For example, each of the RBs includes seven symbols (1=0, . . . , 6) on a time axis and twelve subcarriers on a frequency axis. In this case, each RB includes 84 (7×12=84) resource elements (REs). The DL data transmission from the base station 10 to the user equipment 30 is performed in an RB unit. The DL data transmission in the LTE DL frame structure is performed through a physical downlink shared channel (PDSCH), and the transmission of the DL control information is performed through a physical downlink control channel (PDCCH), a physical control format indicator channel (PCFICH), and a physical hybrid ARQ indicator channel (PHICH). As a DL synchronization channel, there are a primary synchronization channel (P-SCH) and a secondary synchronization Channel (S-SCH). Further, a reference signal (RS) is used for coherent detection and measurement of the DL data and DL control information.

Referring to FIG. 3, definitions of the TTI, slot, RB and RE in the LTE UL frame structure are identical to those in the LTE DL frame structure. The UL data transmission in the LTE UL frame structure is performed through a Physical Uplink Shared CHannel (PUSCH), and the transmission of the UL control information is performed through a Physical Uplink Control CHannel (PUCCH). A sounding reference signal (SRS) is used for UL channel measurement, and a transmission position of the SRS may be on the last symbol (1=6) (not shown) of the second slot (odd-numbered slot) in the TTI. Further, an RS is used as a signal for coherent detection and measurement of UL data and UL control information.

In LTE Release 8, physical layer signals such as PUCCH, PUSCH, SRS and the like are transmitted to an uplink (from the user equipment to the base station). The PUCCH is a channel of a physical layer for transmission of the uplink control signal, and uplink scheduling request information (SR), acknowledgement information associated with the downlink data transmission (HARQ ACK/NACK), and channel quality information (CQI/PMI/RI) may be transmitted through the PUCCH channel. The PUSCH is a physical channel for mainly transmitting data of the user equipment 30, and when one user equipment 30 needs to transmit data and control signals simultaneously, the data and the control signals are multiplexed and transmitted through this channel The SRS is used to measure channel quality of the uplink in the base station 10 or to measure timing information for time synchronization between the base station 10 and the user equipment 30. In the control information transmitted through the PUCCH, the SR and CQI/PMI/RI are transmitted in a specific period and the SRS is also transmitted at a predetermined time interval. For example, transmission periods of the respective SR, CQI/PMI/RI and SRS may be 1/2/5/10/20/40/80 ms, 2/5/10/20/40/80/32/64/128 ms and 2/5/10/20/40/80/160/320 ms. A transmission sub-frame and a transmission period of each signal are set in the base station 10 for each relay 20 through signaling of an upper layer.

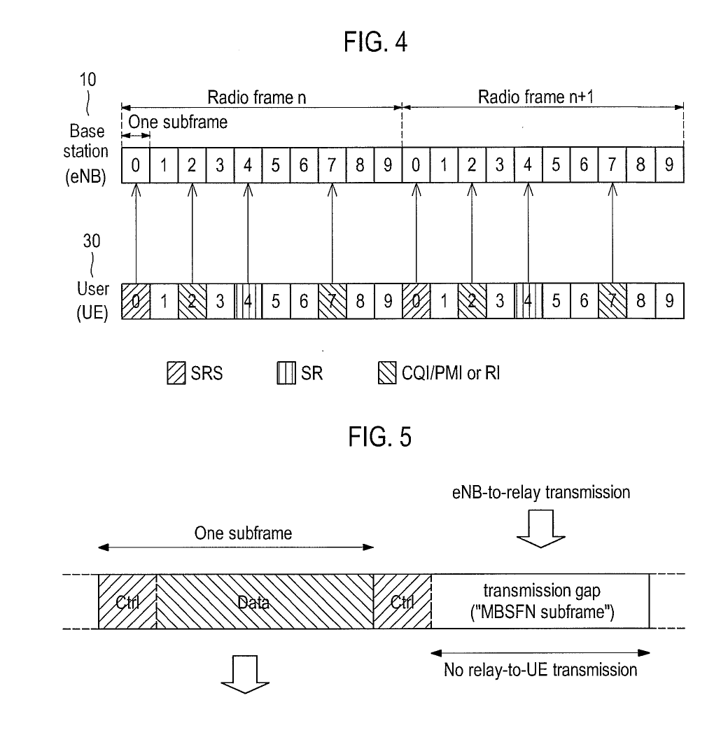

An example of transmitting the signals with periodicity, i.e., the SR, CQI/PMI/RI and SRS are illustrated in FIG. 4.

In the LTE Release 8, one radio frame has a length of 10 ms and includes 10 sub-frames. One sub-frame has a length of 1 ms and also becomes a basic transmission time interval (1 TTI=2 slots). In FIG. 4, each of the SRS and SR is transmitted at an interval of 10 ms, and the SRS and SR are transmitted at a 0^{th} sub-frame and a 4^{th} sub-frame of a radio frame (# n), respectively. Further, the CQI/PMI/RI is transmitted at an interval of 5 ms and at 2^{nd} and 7^{th} sub-frames of the radio frame (# n).

Since the relay 20 operates in a half-duplex way for avoiding occurrence of the SI, simultaneous transmission and reception may be impossible. That is, during a time period in that the relay 20 receives a signal from the base station 10 through the backhaul link, the relay 20 cannot transmit any signals including PDCCH and a cell-specific reference signal or common reference signal (CRS) to the user equipment 30 through an access link. The data transmission of the relay 20 from the base station 10 to each relay 20 is possible during only a time period defined as a transmission gap (TG). In the 3GPP, this TG is defined as a multimedia broadcast single frequency network (MBSFN) sub-frame, the setting of the MBSFN sub-frame is performed through signaling of an upper layer.

As illustrated in FIG. 5, the relay 20 receive signals from the base station 10 during only the time period designated as the MBSFN sub-frame, which is defined as the TG. In this time period, the relay 20 does not transmit any signals to user equipments 30 within coverage thereof. The relay 20 merely transmits the PDCCH and CRS to the user equipments 30 within the coverage thereof by using a first OFDM symbol or first and second OFDM symbols of a sub-frame designated as the MBSFN sub-frame. Also, the relay 20 transmits the entire signals including the PDCCH and CRS to the user equipments 30 connected to the relay 20 through the whole of the sub-frames, which are not designated as the MBSFN sub-frame, and does not receive any signals from the base station 10.

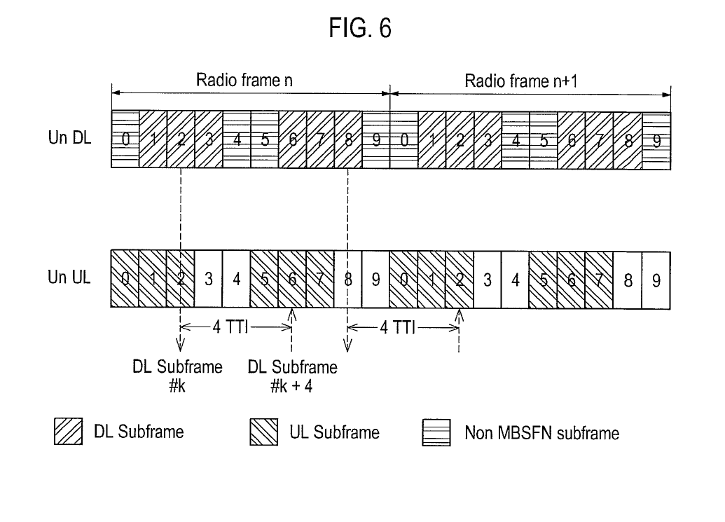

Looking at the MBSFN sub-frames, the sub-frames, which cannot be designated as the MBSFN sub-frames among 10 sub-frames within one radio frame having a length of 10 ms, are 0^{th}, 4^{th}, 6^{th} and 9^{th} sub-frames. Since theses intervals of the 0^{th}, 4^{th}, 5^{th} and 9^{th} sub-frames are used to transmit a synchronization signal (SS), a physical broadcasting channel, system information and paging information, they cannot be designated as the MBSFN sub-frames. Therefore, the maximum sub-frames to be designated as the MBSFN sub-frames within one radio frame are six sub-frames (i.e., 1^{st}, 2^{nd}, 3^{rd}, 6^{th}, 7^{th} and 8^{th} sub-frames). An allocation period of the sub-frames may be set at an interval of 10 ms or 40 ms. In one embodiment, when the radio frame has an allocation period of 10 ms, the MBSFN sub-frames, which have been designated within one radio frame, are alternately designated at every radio frame. In another embodiment, when the radio frame has an allocation period of 40 ms, the MBSFN sub-frames, which have been designated at four successive radio frames, are alternately designated at an interval of 40 ms. In further another embodiment, in 3GPP, sub-frames, which can be used as downlink backhaul sub-frames, are designated as MBSFN sub-frames, and uplink back haul sub-frames are limited by downlink backhaul sub-frames. That is, as illustrated in FIG. 6, if the downlink backhaul sub-frame (MBSFN sub-frame) is designated at a k^{th} sub-frame, the uplink backhaul sub-frame is designated at a (k+4)^{th} sub-frame. For example, if the downlink backhaul sub-frames (MBSFN sub-frames) are 1^{st}, 2^{nd}, 3^{rd}, 6^{th}, 7^{th} and 8^{th} sub-frames, the sub-frames to be used as the uplink backhaul sub-frames become 0^{th}, 1^{st}, 2^{nd}, 5^{th}, 6^{th} and 7^{th} sub-frames. The relay 20 limits data transmission to the uplink at sub-frames, which are not the uplink backhaul sub-frames. That is, the uplink data are not transmitted at the 3^{rd}, 4^{th}, 8^{th} and 9^{th} sub-frames.

Meantime, an allocation period of the current backhaul sub-frames is 40 ms, and this allocation period includes 40 sub-frames. In such a case, the allocation of the backhaul sub-frames is determined by a constitution period of 8 ms, and this constitution period represents an allocation pattern consisting of 8 sub-frames. The constitution period has different 8 patterns and each of the patterns is represented with 8 bits. The constitution period for each relay is determined through signaling of an upper layer at the base station 10. Possible allocation patterns are {00000001}, {00000010}, {00000100}, {00001000}, {00010000}, {00100000}, {01000000} and {10000000}, wherein 1 represents allocation of the sub-frame. The 8 allocation patterns are combinable with each other. In such a case, 255 (2⁷+2⁶+2⁵+2⁴+2³+2²+2¹+2⁰) patterns are possible.

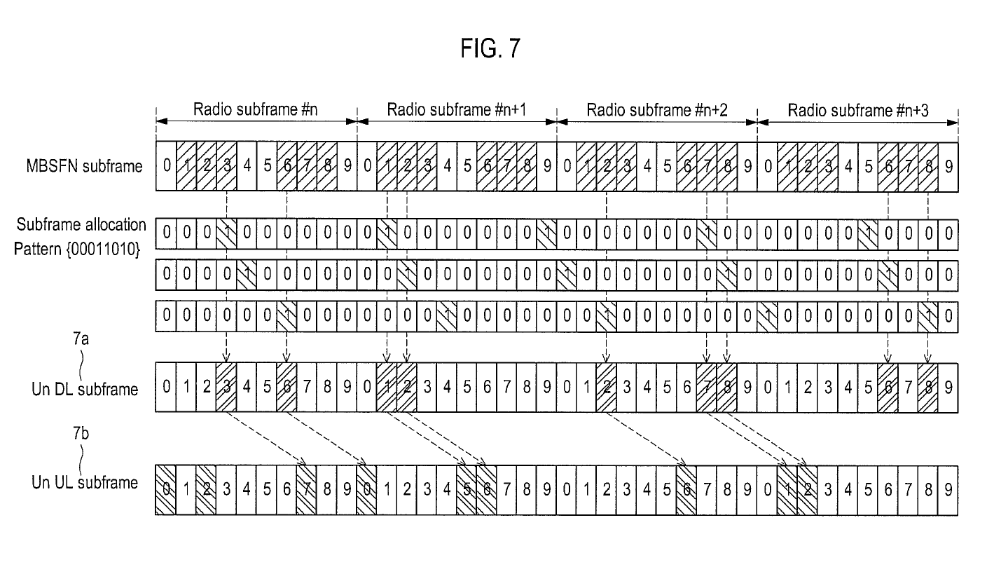

FIG. 7 shows an example of the backhaul sub-frame allocation. In FIG. 7, a backhaul allocation pattern {00011010} is used as one embodiment. This pattern is determined by combination of {00010000}, {00001000} and {00000010}. The MBSFN sub-frames are 1^{st}, 2^{nd}, 3^{rd}, 6^{th}, 7^{th}, and 8^{th} sub-frames of each radio frame. In case that the allocation pattern is {00010000}, a 3^{rd} sub-frame in an n^{th} radio frame may be allocated as the backhaul sub-frame and a 1^{st} sub-frame in a next (n+1)^{th} radio frame may be possible only as the backhaul sub-frame. In this time, since a 9^{th} sub-frame of the (n+1)^{th} radio frame is not the MBSFN sub-frame, the 9^{th} sub-frame is not allocated as the backhaul sub-frame. Also, a 7^{th} sub-frame in a (n+2)^{th} radio sub-frame may be allocated as the backhaul sub-frame, and since a 5^{th} sub-frame in a next (n+3)^{th} sub-frame is not the MBSFN sub-frame, the 5^{th} sub-frame is not allocated as the backhaul sub-frame. Further, when the MBSFN sub-frames are 1^{st}, 2^{nd}, 3^{rd}, 6^{th}, 7^{th} and 8^{th} sub-frames in each radio frame and the allocation pattern is {00001000}, a 4^{th} sub-frame in an n^{th} radio frame is not the backhaul sub-frame, so that the 4^{th} sub-frame is not allocated as the backhaul sub-frame. A 2^{nd} sub-frame in a next (n+1)^{th} radio frame is allocable as the backhaul sub-frame, and only a 8^{th} sub-frame in a next (n+2)^{th} radio frame is allocable as the backhaul sub-frame. In such a case, since a 0^{th} sub-frame in a (n+2)^{th} radio frame is not the MBSFN sub-frame, the 0^{th} sub-frame is not allocated as the backhaul sub-frame. Also, it may be possible to allocate a 6^{th} sub-frame in a (n+3)^{th} radio frame to the backhaul sub-frame in a (n+3)^{th} radio frame. Further, if the MBSFN sub-frames are 1^{st}, 2^{nd}, 3^{rd}, 6^{th}, 7^{th} and 8 sub-frames in each radio frame and the an allocation pattern is {00010000}, it may be possible to allocate a 6^{th} sub-frame in a n^{th} radio frame to the backhaul sub-frame. Since a 4^{th} sub-frame in a (n+1)^{th} radio frame is not the backhaul sub-frame, the a 4^{th} sub-frame is not allocated as the backhaul sub-frame. Also, it is possible to allocate a 2^{nd} sub-frame in a (n+2)^{th} radio frame to the backhaul sub-frame and it is possible to allocate an 8^{th} sub-frame in a next (n+3)^{th} radio frame to the backhaul sub-frame. In such a case, a 0^{th} sub-frame in the (n+3)^{th} radio frame is not the MBSFN sub-frame, so that the 0^{th} sub-frame in the (n+3)^{th} radio frame is not allocated as the backhaul sub-frame.

Assuming that the MBSFN sub-frame is 1^{st}, 2^{nd}, 3^{rd}, 6^{th}, 7^{th} and 8^{th} sub-frames in each radio frame and the constitution period of 8 ms has an allocation pattern of {00011010} according to the backhaul sub-frame allocation condition as above, the downlink backhaul sub-frames are 3^{rd} and 6^{th} sub-frames in the n^{th} radio frame, 1^{st} and 2^{nd} sub-frames in the (n+1)^{th} radio frame, 2^{nd}, 7^{th} and 8^{th} sub-frames in the (n+2)^{th} radio frame and 6^{th} and 8^{th} sub-frames in the (n+3)^{th} radio frame such as “7a.” If the downlink backhaul sub-frames are allocated such as “7a,” then uplink backhaul sub-frames are allocated to a (k+4)^{th} sub-frame to thereby become 0^{th}, 2^{nd} and 7^{th} sub-frames in the n^{th} radio frame, 0^{th}, 5^{th} and 6^{th} sub-frames in the (n+1)^{th} radio frame, a 6^{th} sub-frame in the (n+2)^{th} radio frame and 1^{st} and 2^{nd} sub-frames in the (n+3)^{th} radio frame, such as “7b.”

Concerning this backhaul sub-frame allocating method, a problem for transmission of signals such SR, SRS, CQI/PMI/RI etc. with periodicity may occur in the relay 20. This will be described in detail as follows.

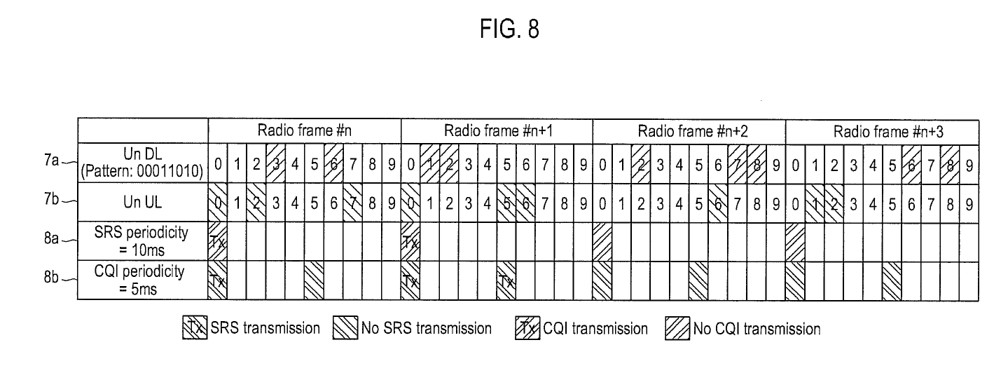

FIG. 8 shows a transmission example of signals with periodicity in a backhaul link. It is assumed that the MBSFN sub-frames are 1^{st}, 2^{nd}, 3^{rd}, 6^{th}, 7^{th} and 8^{th} sub-frames in each radio frame and the constitution period of 8 ms has an allocation pattern of {00011010}, such as FIG. 7. Under this allocation pattern, a downlink backhaul sub-frame (7a) is allocated and then an uplink backhaul sub-frame (7b) is allocated on a basis thereof. In such a case, if SRS has a transmission period of 10 ms and CQI has a transmission period of 5 ms, then SRS, which is transmitted to uplink, should be transmitted four times within 40 ms. However, twice transmission is allowable (8a). CQI, which is transmitted to the uplink, should be transmitted eight times within 40 ms, however, triple transmission is allowable (8b). Thus, the backhaul sub-frames to be transmitted to the uplink are limited, so that a chance for transmitting signals having the periodicity is decreased.

In one embodiment, the periods of SR, SRS and CQI/PMI/RI, which are specified in LTE Release 8, may be used identically and the periods may be limited. The base station 10 sets the transmission periods of SR, SRS and CQI/PMI/RI and the constitution period of 8 ms for the backhaul sub-frame for each relay 20 through signaling of an upper layer. In one embodiment, as for the transmission period for each signal, the transmission period may be set to 1/2/5/10/20/40/80 ms for SR, 2/5/10/20/40/80/160/320 ms for SRS and 2/5/10/20/40/80/32/64/128 ms for CQI/PMI/RI. In another embodiment, the transmission periods of SR, SRS and CQI/PMI/RI are set to be transmitted at the uplink backhaul sub-frames and the transmission periods may be set to 40/80 ms for SR, 40/80/160/320 ms for SRS and 40/80 ms for CQI/PMI/RI. Like this, if the transmission periods of SR, SRS and CQI/PMI/RI are set over 40 ms, which are free from the limitation of the sub-frames, the signals with periodicity are not limited. The reason is that the radio frame typically has an allocation period (backhaul sub-frame allocation period) of 40 ms. In such a case, however, since many portions of the periods may not be used, the setup of the transmission period may be limited.

Thereafter, the relay 20 determines uplink and downlink backhaul sub-frames based on the set constitution period of 8 ms. That is, the downlink backhaul sub-frames are determined based on the constitution period of 8 ms, and the uplink backhaul sub-frames are determined, which are limited by the downlink backhaul sub-frames. For example, when the downlink backhaul sub-frames are k^{th} sub-frames (see 7a in FIG. 7 or FIG. 8), the uplink backhaul sub-frame is set to a (k+4)^{th} sub-frame (see 7b in FIG. 7 or FIG. 8). If the uplink backhaul sub-frame 7a is determined, then transmission sub-frames are determined based on the transmission period of each of SR, SRS and SQI/PMI/RI. Thereafter, if the transmission frames of each of SR, SRS and CQI/PMI/RI are the uplink backhaul sub-frames, then the signals are transmitted, and if not, then the signals are not transmitted.

Especially, the transmission period of SR, SRS and CQI/PMI/RI may be ignored at the above case. In one embodiment, the relay 10 transmits SR, SRS and CQI/PMI/RI at all of the uplink backhaul sub-frames in a radio frame of 40 ms. That is, if SR, SRS and CQI/PMI/RI are transmitted at all of the uplink backhaul sub-frames within 40 ms, specific periods for these signals are not used and these signals are entirely transmitted at the sub-frames allocated as the uplink backhaul. This is that portions or all of the uplink control signals (i.e., SR, SRS, CQI/PMI/RI) in all of the uplink backhaul sub-frames within the backhaul sub-frame allocation period are transmitted. For example, if the uplink backhaul sub-frames are allocated such as “7b” in FIG. 8, SR, SRS and CQI/PMI/RI are always transmitted at the allocated sub-frames, i.e., 0^{th}, 2^{nd} and 7^{th} sub-frames in an n^{th} radio frame, 0^{th}, 5^{th} and 6^{th} sub-frames of a (n+1)^{th} radio frame, a 6^{th} sub-frame of a (n+2)th radio frame and 1^{st} and 2^{nd} sub-frames of an (n+3)^{th} radio frame, regardless of the transmission period.

In another embodiment ignoring the transmission period of SR, SRS and CQI/PMI/RI, the relay 20 transmits SR, SRS and CQI/PMI/RI only at a first uplink backhaul sub-frame in the radio frame of 40 ms. That is, if the SR, SRS and CQI/PMI/RI are transmitted only at a first uplink backhaul sub-frame within the radio frame of 40 ms, the signals are entirely transmitted at the first uplink backhaul sub-frame without using a specific transmission period. This is that portion or all of the uplink signals (i.e., SR, SRS and CQI/PMI/RI) are transmitted at the first uplink backhaul sub-frame within the backhaul sub-frame allocation period. For example, if the uplink backhaul sub-frames are allocated such as “7b” in FIG. 8, the SR, SRS and CQI/PMI/RI are transmitted at a 0^{th} sub-frame of an n^{th} radio frame regardless of the transmission period. A next transmission period of these signals become a 0^{th} sub-frame of an (n+4)^{th} radio frame.

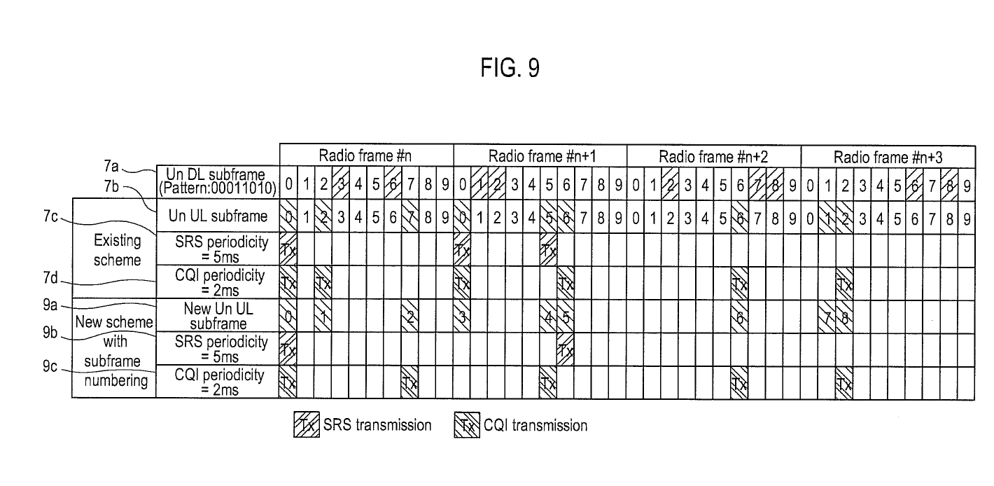

Meantime, the relay 20 determines the downlink backhaul sub-frames 7a and the uplink backhaul sub-frames 7b based on the set constitution period of 8 ms and then newly assign a sub-frame number sequentially to each of the determined uplink backhaul sub-frames 7b. The relay 20 determines transmission sub-frames based on the set transmission period of each of SR, SRS and CQI/PMI/RI by considering the newly assigned sub-frame numbers, and then transmits the SR, SRS and CQI/PMI/RI at the transmission sub-frames. This is that the uplink backhaul sub-frames are numbered and portions or all of the uplink control signals (i.e., SR, SRS and CQI/PMI/RI) according to the uplink backhaul sub-frame numbers, which are newly defined within the backhaul sub-frame allocation period, are transmitted. This process will be described in detail by referring to FIG. 9.

As shown in FIG. 9, assuming that the MBSFN sub-frames are 1^{St}, 2^{nd}, 3^{rd}, 6^{th}, 7^{th} and 8^{th} sub-frames in each radio frame and the constitution period of 8 ms has an allocation pattern of {00011010}, the downlink backhaul sub-frames 7a are designated to 3^{rd} and 6^{th} sub-frames in the n^{th} radio frame, 1^{st} and 2^{nd} sub-frames in the (n+1)^{th} radio frame, 2^{nd}, 7^{th} and 8^{th} sub-frames in the (n+2)^{th} radio frame and 6^{th} and 8^{th} sub-frames in the (n+3)^{th} radio frame such as “7a,” and the uplink backhaul sub-frames 7b are designated to 0^{th}, 2^{nd} and 7^{th} sub-frames in an nth radio frame, 0^{th}, 5^{th} and 6^{th} sub-frames in an (n+1)th radio frame, a 6^{th} sub-frame in an (n+2)th radio frame and 1^{st} and 2^{nd} sub-frames in an (n+3)th radio frame. In this time, if a transmission period of signals to be transmitted has bee determined, the transmission is determined by referring to this value of the sub-frame. If the period of SRS is 5 ms, the SRS transmission has to be performed at 0^{th} and 5^{th} sub-frames of each radio frame, however the transmission is performed at a 0^{th} sub-frame in an nth radio frame and 0^{th} and 5^{th} sub-frames in an (n+1)th radio frame due to the limitation of the backhaul sub-frames (see 7c). Also, if a period of CQI is 2 ms, the CQI transmission has to be performed at 0^{th}, 2^{nd}, 4^{th}, 6^{th} and 8^{th} sub-frames in each radio frame. However, the transmission is performed at 0^{th} and 2^{nd} sub-frames in an nth radio frame, 0^{th} and 6^{th} sub-frames in an (n+1)th radio frame, a 6^{th} sub-frame in an (n+2) radio frame and a 2^{nd} sub-frame in an (n+3)th radio frame due to the limitation of the backhaul sub-frames (see 7d).

If the uplink backhaul sub-frames are numbered consecutively (see 9a), the limitation of the sub-frames may not be considered in setting the transmission period. That is, 0^{th}, 5^{nd} and 7^{th} sub-frames in an nth radio frame, 0^{th}, 5^{th} and 6^{th} sub-frames in an (n+1)th radio frame and 1^{st} and 2^{nd} sub-frames in an (n+3)th radio frame, which are designated as the uplink backhaul sub-frames of a radio frame having an allocation period of 40 ms, are sequentially numbered (see 9a). If the transmission period of SRS is 5 ms, SRS can be transmitted at newly numbered 0^{th} and 5^{th} sub-frames (see 9b). Also, if the transmission period of CQI is 2 ms, CQI can be transmitted at 0^{th}, 2^{nd}, 4^{th}, 6^{th} and 8^{th} sub-frames (see 9c). In this method, SR/SRS/CQI/PMI/RI can be periodically transmitted according to the uplink backhaul sub-frame allocation.

Any reference in this specification to “one embodiment,” “an embodiment,” “example embodiment,” “illustrative embodiment,” etc. means that a particular feature, structure or characteristic described in connection with the embodiment is included in at least one embodiment of the present invention. The appearances of such phrases in various places in the specification are not necessarily all referring to the same embodiment. Further, when a particular feature, structure or characteristic is described in connection with any embodiment, it is submitted that it is within the purview of one skilled in the art to affect such feature, structure or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, numerous variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A backhaul timing control method, comprising:
a) transmitting, at a relay, a control signal to a user equipment during a control symbol period of a sub-frame; and
b) setting, at the relay, a data starting point of the sub-frame after a time (SG1) for switching from a transmission mode to a reception mode to receive backhaul data of a base station during backhaul symbol periods.

2. The method of claim 1, further comprising delaying, at the relay, timing of a transmission sub-frame and a reception sub-frame by the SG1.

3. The method of claim 2, further comprising transmitting, at the relay, the control signals to the user equipment during a control symbol period of a next sub-frame after a time for switching the reception mode to the transmission mode (SG2).

4. The method of claim 3, wherein a sum of lengths of the SG1 and SG2 is shorter than a length of a symbol (Ln) having a normal cyclic prefix (CP).

5. The method of claim 4, wherein the lengths of the SG1 and the SG2 are identical to each other and each length of the SG1 and the SG2 is longer than a length of the CP.

6. The method of claim 5, wherein the step b) includes receiving the backhaul data of the base station up to a last symbol period of backhaul symbols of the receiving sub-frame.

7. The method of claim 4, wherein the length of the SG2 is shorter than the length of the SG1 and each length of the SG1 and the SG2 is longer than a length of the CP.

8. The method of claim 1, further comprising delaying, at the relay, timing of a transmission sub-frame and a reception sub-frame by an amount resulting from subtracting the SG1 from a length of a symbol having a normal cyclic prefix (CP).

9. The method of claim 8, wherein the sum of the lengths of the SG1 and the SG2 is longer than the length of Ln.

10. The method of claim 9, wherein the lengths of the SG1 and the SG2 are identical to each other and each length of the SG1 and the SG2 is longer than the length of the CP.

11. The method of claim 10, wherein the step b) includes receiving, at the relay, backhaul data of the base station up to a symbol prior to a last symbol of the received sub-frame.

12. The method of claim 8, wherein a length of the SG2 is shorter than a length of the Ln and longer than a length of the CP.

13. A relay system, comprising:
a relay configured to transmit a control signal to a user equipment during a control symbol period of a sub-frame and set a data starting point of the sub-frame next to a time (SG1) for switching from a transmitting mode to a reception mode to receive backhaul data of a base station during backhaul symbol periods.

14. The relay system of claim 13, wherein timing of a transmission sub-frame and a reception sub-frame is delayed by the SG1.

15. The relay system of claim 14, wherein the control signals are transmitted to the user equipment during a control symbol period of a next sub-frame after a time (SG2) for switching from the reception mode to the transmission mode.

16. The relay system of claim 15, wherein a sum of lengths of the SG1 and SG2 is shorter than a length of a symbol (Ln) having a normal cyclic prefix (CP).

17. The relay system of claim 16, wherein the lengths of the SG1 and the SG2 are identical to each other and each length of the SG1 and the SG2 is longer than a length of the CP, and
wherein the relay system is configured to receive the backhaul data of the base station up to a last symbol period of a backhaul symbol of the received sub-frame.

18. The relay system of claim 13, wherein the relay system is configured to delay timing between a transmission sub-frame and a reception sub-frame by an amount resulting from subtracting the SG1 from a length of a symbol having a normal cyclic prefix (CP), and
wherein the sum of the lengths of the SG1 and the SG2 is longer than the length of LN.

19. The relay system of claim 18, wherein the lengths of the SG1 and the SG2 are identical to each other
